(19) United States
(12) Patent Application Publication
(10) Pub. No.: US 2026/0014942 A1
(43) Pub. Date: Jan. 15, 2026

(54) ROOF LINING AND PRODUCTION METHOD OF ROOF LINING

(71) Applicant: YKK CORPORATION, Tokyo (JP)

(72) Inventors: Mariko NAKASE, Kurobe-shi (JP); Yoshitomo IYODA, Tokyo (JP); Yuta INOUE, Tokyo (JP)

(21) Appl. No.: 19/267,273

(22) Filed: Jul. 11, 2025

(30) Foreign Application Priority Data
Jul. 12, 2024 (JP) 2024-112443

(51) Int. Cl. B60R 13/02

(52) U.S. Cl. CPC B60R 13/0231; B60R 2013/0293

(57) ABSTRACT

A roof lining includes: a lining material including a plurality of divided pieces to define an opening corresponding to a sunroof of a vehicle body; and a plurality of slide fasteners, each of which couples corresponding adjacent ones of the divided pieces. The slide fasteners traverse the lining material from the opening to an outer edge of the lining material.

### CROSS REFERENCE TO RELATED APPLICATIONS

The entire disclosure of Japanese Patent Application No. 2024-112443 filed Jul. 12, 2024 is expressly incorporated by reference herein.

### TECHNICAL FIELD

The present invention relates to a roof lining attached to a vehicle body of an automobile or the like and a production method of the roof lining.

### BACKGROUND ART

As a typical interior member attached to a vehicle body of an automobile or the like, there is a roof lining having an opening corresponding to a sunroof (see, for instance, Patent Literature 1: JP 2017-100660 A).

In general, in producing such a roof lining as disclosed in Patent Literature 1, a lining material forming the roof lining is molded and then a portion corresponding to an opening is cut out from the lining material. However, such a production method involves disposal of the portion of the lining material corresponding to the opening, which makes it difficult to improve a yield.

### SUMMARY OF THE INVENTION

An object of the invention is to provide a roof lining having an opening corresponding to a sunroof and being capable of improving a yield in production, and a production method of the roof lining.
[1] According to an aspect of the invention, a roof lining includes: a lining material including a plurality of divided pieces to define an opening corresponding to a sunroof of a vehicle body; and a plurality of slide fasteners, each of which is configured to couple adjacent ones of the divided pieces, in which the slide fasteners traverse the lining material from the opening to an outer edge of the lining material.
[2] In the above [1], the slide fasteners are preferably disposed along a front-back direction of the vehicle body.
[3] In the above [1], the slide fasteners are preferably respectively attached to portions of the lining material which are on an identical plane.
[4] In the above [1], the slide fasteners are preferably attached to a portion having a smallest thickness of the lining material.
[5] In the above [1], preferably, each of the slide fasteners includes a pair of fastener stringers respectively attached to adjacent ones of the divided pieces and configured to be engaged with each other, and the fastener stringers respectively include: tapes respectively attached to corresponding ones of the divided pieces, and element arrays attached to the respective tapes.
[6] In the above [5], preferably, each of the divided pieces has divided ends, each of which is adjacent to a corresponding one of the divided pieces, and each of the element arrays is disposed to overlap a corresponding one of the divided ends in a thickness direction of the lining material.
[7] In the above [1], optionally, the lining material includes: a base having a single-layered or multi-layered structure; and a cover material covering a surface of the base on a first side in the thickness direction of the lining material, and the slide fasteners are disposed on a second side in the thickness direction of the lining material with respect to the lining material.
[8] In the above [1], optionally, each of the slide fasteners is partially exposed toward a first side in the thickness direction of the lining material, from between adjacent ones of the divided pieces.
[9] In the above [8], optionally, each of the divided pieces has divided ends, each of which is adjacent to a corresponding one of the divided pieces, and each of the divided ends is folded together with a portion of a corresponding one of the slide fasteners toward a second side in the thickness direction of the lining material.
[10] In the above [1], optionally, each of the divided pieces has divided ends, each of which is adjacent to a corresponding one of the divided pieces, each of the divided ends has a base-side region connected to a body of a corresponding one of the divided pieces and a distal-side region folded to overlap the base-side region, and each of the slide fasteners is disposed on the distal-side regions of adjacent ones of the divided ends.
[11] In the above [6], [9] or [10], optionally, the lining material includes: a base having a single-layered or multi-layered structure; and a cover material covering a surface of the base on a first side in the thickness direction of the lining material, and at least a part of the base is removed from each of the divided ends.
[12] According to another aspect of the invention, a production method of a roof lining includes: forming, as a lining material, a plurality of divided pieces that define an opening corresponding to a sunroof of a vehicle body; and coupling adjacent ones of the divided pieces using a corresponding one of slide fasteners, in which the slide fasteners traverse the lining material from the opening to an outer edge of the lining material.

### BRIEF DESCRIPTION OF DRAWINGS

FIG. 1 is a plan view illustrating a roof lining in a first exemplary embodiment.

FIG. 2 is a cross-sectional view taken along an A-A line in FIG. 1.

FIG. 3 is a partial cross sectional view illustrating divided ends of the roof lining in the first exemplary embodiment.

FIG. 4 is a partial cross sectional view illustrating an example of divided ends of a roof lining in a second exemplary embodiment.

FIG. 5 is a partial cross sectional view illustrating another example of the divided ends of the roof lining in the second exemplary embodiment.

FIG. 6 is a partial cross sectional view illustrating divided ends of a roof lining in a third exemplary embodiment.

FIG. 7 is a partial cross sectional view illustrating divided ends of a roof lining in a fourth exemplary embodiment.

FIG. 8 is a partial cross sectional view illustrating an example of divided ends of a roof lining in a fifth exemplary embodiment.

FIG. 9 is a partial cross sectional view illustrating another example of the divided ends of the roof lining in the fifth exemplary embodiment.

### DETAILED DESCRIPTION

Exemplary embodiments of the invention will be described below with reference to drawings attached. In second, third, fourth, and fifth exemplary embodiments, the same reference numerals as in a first exemplary embodiment are used for the same configurations as in the first exemplary embodiment, and descriptions of those structures are omitted or simplified.

### First Exemplary Embodiment

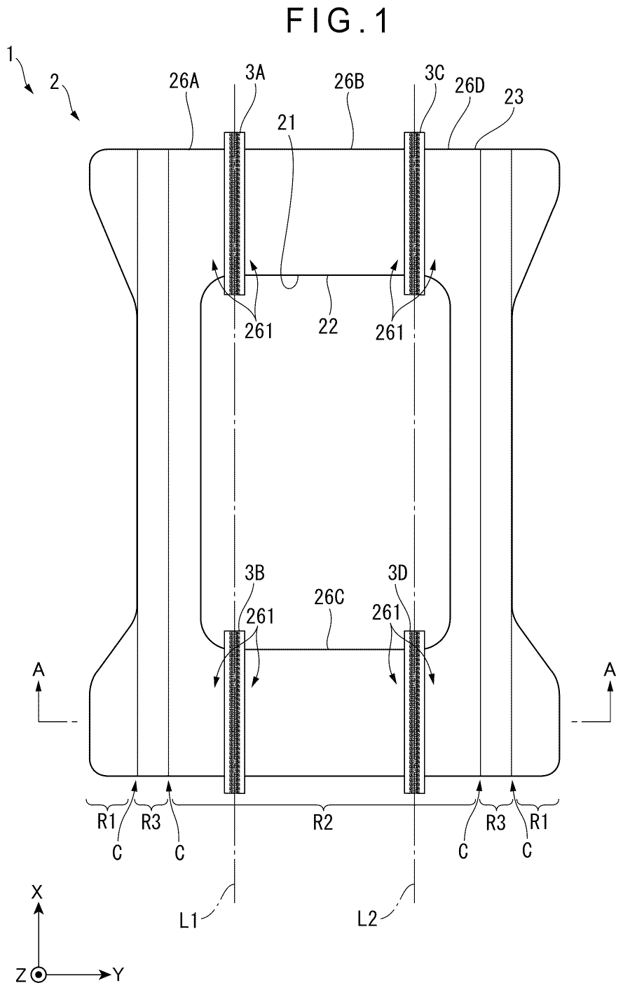

The first exemplary embodiment of the invention will be described with reference to FIGS. 1 to 3.

A roof lining 1 of the exemplary embodiment is an interior member attached on a ceiling (not illustrated) of a vehicle body having a sunroof. The roof lining 1 includes: a lining material 2 including a plurality of divided pieces 26A to 26D to define an opening 21 corresponding to the sunroof; and a plurality of slide fasteners 3A to 3D, each of which couples the corresponding ones of the divided pieces 26A to 26D.

The sunroof herein refers to a window provided in a ceiling of a vehicle body. In the exemplary embodiment, the sunroof is assumed to be provided in a center portion of the ceiling of the vehicle body. However, the arrangement of the sunroof in the ceiling is not limited thereto but can be altered optionally. The vehicle body is not limited to a vehicle body of an automobile but may be a vehicle body of any means of transportation.

Description will be made below using an X direction, Y direction, and Z direction orthogonal to each other. The X direction corresponds to a travel direction (front-back direction) of the vehicle body to which the roof lining 1 is attached. The Y direction corresponds to a width direction (left-right direction) of the vehicle body. The Z direction, which is a thickness direction of the lining material 2, corresponds to a vehicle height direction (top-down direction) of the vehicle body.

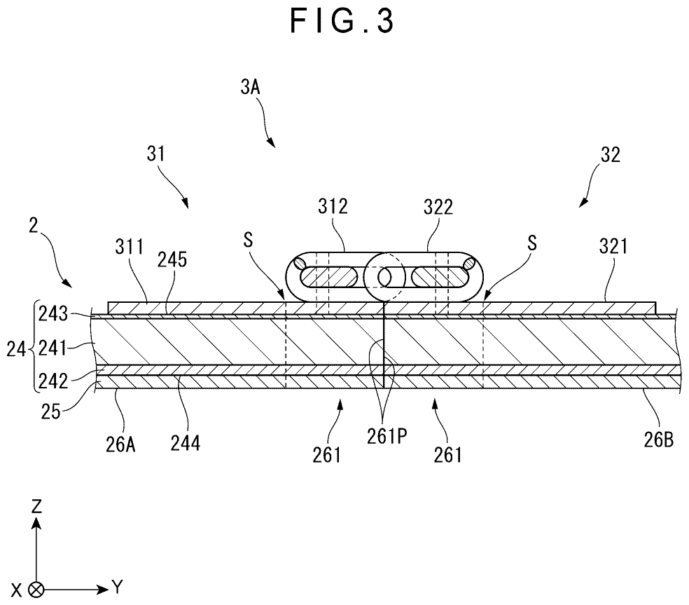

The lining material 2 is a panel member extending along the ceiling of the vehicle body. The lining material 2 includes: a base 24 having a structure of layers stacked in the Z direction; and a cover material 25 covering a −Z side surface 244 of the base 24, as illustrated in FIG. 3. For instance, the base 24 includes a urethane layer 241, and a first glass fiber layer 242 and a second glass fiber layer 243 interposing the urethane layer 241 therebetween. The cover material 25 faces space inside the vehicle body in a-Z direction. The cover material 25 is formed of, for instance, non-woven cloth. It should be noted that the structure of the base 24 is not limited to the multi-layered structure but may be a single-layered structure.

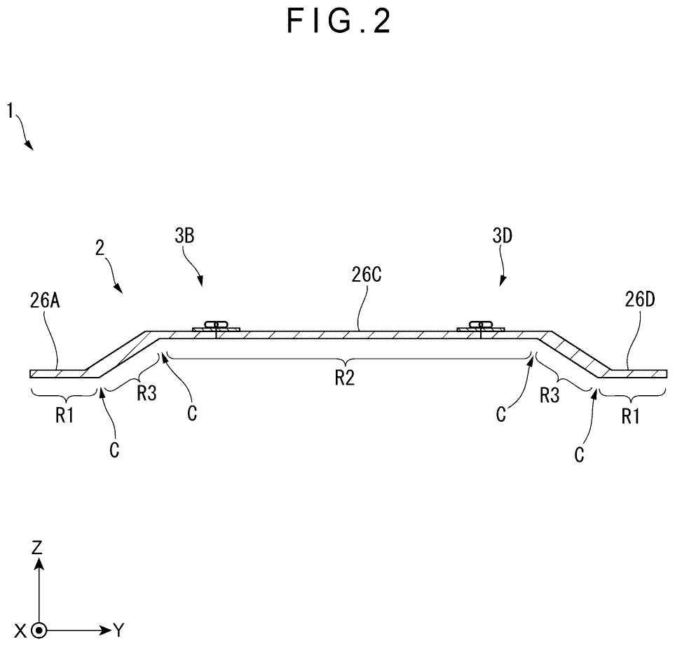

The lining material 2 has a curved shape to conform to a shape of the ceiling of the vehicle body, as illustrated in FIGS. 1 and 2. For instance, the lining material 2 in the exemplary embodiment has a first region R1, a second region R2, and a slanted region R3. The first region R1 is disposed on each end of the lining material 2 in the Y direction. The second region R2 is disposed in a center portion of the lining material 2 in the Y direction and above (on a +Z side of) the first region R1. The slanted region R3 couples the first region R1 and the second region R2 and is slanted with respect to the Z direction. The thickness of the slanted region R3 is larger than the thickness of the first region R1 and the thickness of the second region R2. The thickness of the first region R1 and the thickness of the second region R2 are approximately equal to each other. Further, the lining material 2 has a bent portion C between the first region R1 and the slanted region R3 and a bent portion C between the second region R2 and the slanted region R3.

The opening 21 corresponding to the sunroof is provided in the second region R2 of the lining material 2, as illustrated in FIG. 1. The shape of the opening 21 is not particularly limited as long as it corresponds to the shape of the sunroof. For instance, the opening 21 in the exemplary embodiment has a substantially rectangular shape having a pair of long sides along the X direction and a pair of short sides along the Y direction.

Note that an edge of the lining material 2 close to the opening 21 is referred to as an inner edge 22, and an opposite edge of the lining material 2 from the inner edge 22 in the X direction or the Y direction is referred to as an outer edge 23.

As illustrated in FIG. 1, the lining material 2 includes the plurality of divided pieces 26A to 26D. Note that, in the exemplary embodiment, two parting lines L1 and L2 are assumed to divide the lining material 2 into the divided pieces 26A to 26D. The parting lines L1 and L2 pass through the opening 21 in the second region R2, which is one of regions having the smallest thickness in the lining material 2, while keeping a Y-directional distance between each other. Further, the parting lines L1 and L2 extend along the X direction that is the travel direction of the vehicle body.

In the exemplary embodiment, the divided pieces 26B and 26C disposed across the opening 21 in the X direction are adjacent to the divided piece 26A in the Y direction with the parting line L1 being interposed therebetween. Further, the divided pieces 26B and 26C are adjacent to the divided piece 26D in the Y direction with the parting line L2 being interposed therebetween. Accordingly, each of the divided pieces 26A and 26D has two divided ends 261 adjacent to the respective divided pieces 26B and 26C on one side in the Y direction. Further, each of the divided pieces 26B and 26C has two divided ends 261 adjacent to the respective divided pieces 26A and 26D on both sides in the Y direction.

Each of the slide fasteners 3A to 3D is attached to the divided ends 261 of the corresponding adjacent ones of the divided pieces 26A to 26D, thereby coupling the divided pieces. Specifically, the slide fastener 3A couples the divided pieces 26A and 26B, the slide fastener 3B couples the divided pieces 26A and 26C, the slide fastener 3C couples the divided pieces 26B and 26D, and the slide fastener 3D couples the divided pieces 26C and 26D.

The slide fasteners 3A and 3B are disposed on the parting line L1 of the lining material 2. The slide fasteners 3C and 3D are disposed on the parting line L2 of the lining material 2. Accordingly, the slide fasteners 3A to 3D are disposed in the second region R2, which is one of the regions having the smallest thickness in the lining material 2, and traverse the lining material 2 from the opening 21 to the outer edge 23 of the lining material 2. Further, the slide fasteners 3A to 3D are disposed along the X direction that is the travel direction of the vehicle body.

The slide fasteners 3A to 3D may extend in the X direction beyond the inner edge 22 or the outer edge 23 of the lining material 2. Portions of the slide fasteners 3A to 3D extending beyond the lining material 2 only need to be put between the lining material 2 and the vehicle body so as not to be visual from inside the vehicle body.

Detailed configurations of the slide fasteners 3A to 3D are not particularly limited. Any slide fastener is usable. The slide fasteners 3A to 3D have similar configurations, and therefore, the slide fastener 3A will be representatively described below.

As illustrated in FIG. 3, the slide fastener 3A in the exemplary embodiment is a typical coil fastener. This slide fastener 3A includes a pair of fastener stringers 31 and 32 to be engaged with each other. The fastener stringers 31 and 32 are respectively attached to the divided ends 261 of the divided pieces 26A and 26B adjacent.

The fastener stringer 31 includes a tape 311 attached to the divided piece 26A, and a coil-shaped element array 312 attached to one end of the tape 311. The tape 311 is placed on a +Z side surface 245 of the base 24 in the divided piece 26A and is attached by sewing to the divided end 261 of the divided piece 26A. A sewing position S of the tape 311 is, for instance, near the element array 312 and at a predetermined distance from an end surface 261P in the divided end 261. The element array 312 is disposed on a +Z side surface of the tape 311 and is attached to an end of the tape 311 in a width direction. Further, the element array 312 is disposed on the +Z side of the divided end 261 of the divided piece 26A, thereby overlapping the divided end 261 with the tape 311 being interposed therebetween.

The fastener stringer 32 includes a tape 321 attached to the divided piece 26B, and a coil-shaped element array 322 attached to one end of the tape 321. Each configuration of the fastener stringer 32 is the same as that of the fastener stringer 31 except that the fastener stringer 32 and the fastener stringer 31 are symmetrical in the Y direction.

The slide fastener 3A described above couples the divided pieces 26A and 26B by the element arrays 312 and 322 of the fastener stringers 31 and 32 engaging with each other. With the divided pieces 26A and 26B coupled with each other, the respective end surfaces 261P of the divided ends 261 of the divided pieces 26A and 26B are positioned in contact with or near each other in the Y direction. Therefore, the slide fastener 3A disposed is almost not exposed toward a −Z side from between the divided pieces 26A and 26B.

The slide fastener 3A may be provided with a slider for mutually engaging the element arrays 312 and 322 of the respective fastener stringers 31 and 32. Alternatively, a slider as a jig may be used instead of proving a slider for the slider fastener 3A.

### Production Method of Roof Lining 1

An example of a production method of the roof lining 1 of the exemplary embodiment will be described.

Firstly, the divided pieces 26A to 26D are formed as the lining material 2. A typical method of forming a roof lining is usable as a specific method of forming each of the divided pieces 26A to 26D. The divided pieces 26A to 26D may be transported in an overlapped state with each other to a work site for the next step.

Next, adjacent ones of the divided pieces 26A to 26D are coupled using the corresponding one of the slide fasteners 3A to 3D. Specifically, the fastener stringer 31 (or 32) of each of the slide fasteners 3A to 3D is sewn onto the corresponding one of the divided pieces 26A to 26D. Subsequently, the fastener stringers 31 and 32 of each of the slide fasteners 3A to 3D are engaged with each other.

The roof lining 1 of the exemplary embodiment is thus produced. Subsequently, the roof lining 1 is attached on a ceiling of a vehicle body having a sunroof. Since the roof lining 1 of the exemplary embodiment can be transported after being produced (i.e., with the divided pieces 26A to 26D coupled by the slide fasteners 3A to 3D), a production site of the roof lining 1 may be different from an attachment site of the roof lining 1 to the vehicle body.

### Effects of Exemplary Embodiment

As described above, the roof lining 1 of the exemplary embodiment includes: the lining material 2 including a plurality of divided pieces 26A to 26D to define the opening 21 corresponding to the sunroof of the vehicle body; and a plurality of slide fasteners 3A to 3D, each of which couples adjacent ones of the divided pieces 26A to 26D. The slide fasteners 3A to 3D traverse the lining material 2 from the opening 21 to the outer edge 23 of the lining material 2.

With the above configuration, in producing the roof lining 1, the divided pieces 26A to 26D only need to be coupled with each other after being formed. Accordingly, it is unnecessary to cut for removing a portion corresponding to the opening 21 from the lining material 2.

Further, in the above configuration, since portions of the divided pieces 26A to 26D to be coupled using the slide fasteners 3A to 3D are continuous in line, the divided pieces 26A to 26D can be reliably coupled.

Therefore, the exemplary embodiment allows a yield in production of the roof lining 1 to improve.

In the exemplary embodiment, the slide fasteners 3A to 3D are disposed along the front-back direction (X direction) of the vehicle body. With such a configuration, boundary lines (i.e., parting lines L1 and L2) between the divided pieces 26A to 26D of the roof lining 1 are aligned in the front-back direction (i.e., the travel direction) of the vehicle body, and therefore, even when the parting lines L1 and L2 come within sight of passengers while driving, the passengers are not likely to get motion sickness.

In the exemplary embodiment, the lining material 2 has bent portions C conforming to a shape of the ceiling of the vehicle body, and the slide fasteners 3A to 3D are attached to portions, on an identical plane (i.e., in a region other than the bent portions C), of the lining material 2. This facilitates sewing the slide fasteners 3A to 3D onto the divided pieces 26A to 26D in producing the roof lining 1.

In the exemplary embodiment, the slide fasteners 3A to 3D are attached to a portion having the smallest thickness (specifically the second region R2) of the lining material 2. This facilitates sewing the slide fasteners 3A to 3D onto the divided pieces 26A to 26D in producing the roof lining 1.

In the exemplary embodiment, each of the slide fasteners 3A to 3D includes a pair of fastener stringers 31 and 32 respectively attached to adjacent ones of the divided pieces 26A to 26D. The fastener stringers 31 and 32 are engageable with each other. The fastener stringers 31 and 32 respectively include: the tapes 311 and 321 sewn on the corresponding ones of the divided pieces 26A to 26D; and the element arrays 312 and 322 attached to the respective tapes 311 and 321.

In such a configuration, any typical slide fastener is usable as the slide fasteners 3A to 3D.

In the exemplary embodiment, each of the divided pieces 26A to 26D has the divided ends 261, each of which is adjacent to a corresponding one of the divided pieces 26A to 26D, and the element arrays 312 and 322 are disposed to overlap the respective divided ends 261 in the thickness direction (the Z direction) of the lining material 2.

Such a configuration can suppress generation of gaps between the divided ends 261 of adjacent ones of the divided pieces 26A to 26D, thereby preventing damage to appearance of the roof lining 1.

In the exemplary embodiment, the lining material 2 includes: the base 24 having a single-layered or multi-layered structure; and the cover material 25 covering the surface 244 of the base 24 on one side (−Z side) in the thickness direction of the lining material 2. The slide fasteners 3A to 3D are disposed on the other side (+Z side) in the thickness direction of the lining material 2 with respect to the lining material 2.

With such a configuration, the slide fasteners 3A to 3D are disposed between the ceiling of the vehicle body and the lining material 2 when the roof lining 1 is attached to the vehicle body with the cover material 25 facing space inside the vehicle body. This allows for a design in which the slide fasteners 3A to 3D are invisible to passengers.

### Second Exemplary Embodiment

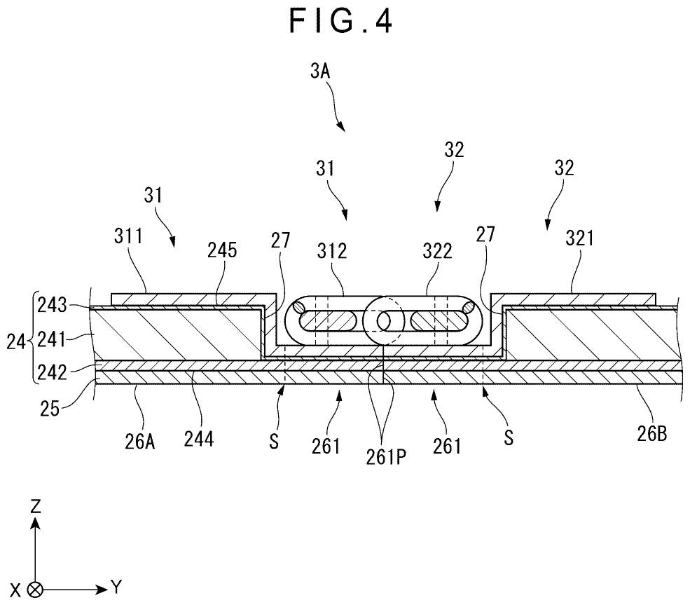

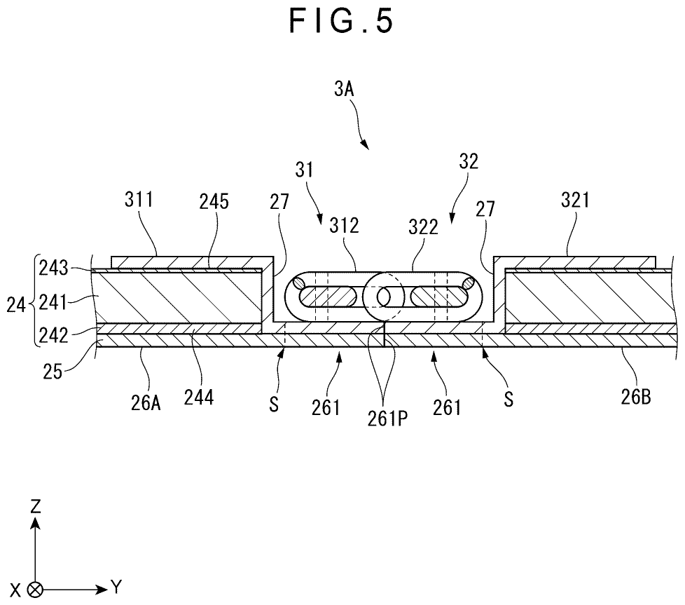

A roof lining 1 of the second exemplary embodiment, which is a modification of the roof lining 1 of the first exemplary embodiment, is different in the details of the divided ends 261 of the divided pieces 26A to 26D. Hereinafter, the divided ends 261 of the divided pieces 26A and 26B coupled by the slide fastener 3A are described as a representative example with reference to FIG. 4 or FIG. 5.

In the exemplary embodiment, at least a part of the base 24 is removed from each of the divided ends 261 of the divided pieces 26A and 26B.

For instance, as illustrated in FIG. 4, the urethane layer 241 may be removed from the base 24 at each of the divided ends 261 of the divided pieces 26A and 26B, and the first glass fiber layer 242, the second glass fiber layer 243, and the cover material 25 may be stacked.

Alternatively, as illustrated in FIG. 5, the base 24 may be entirely removed from the divided ends 261 of the divided pieces 26A and 26B. In this case, only the cover material 25 is present at the divided ends 261.

In the configurations illustrated in FIGS. 4 and 5, a cutout 27, which is opened in the +Z direction and toward one side in the Y direction, is formed in each of the divided ends 261 of the divided pieces 26A and 26B. A Y-directional range of each of the divided ends 261 (i.e., a range in which at least a part of the base 24 is removed) is not particularly limited, and is sufficient as long as the tapes 311 and 321 can be sewn.

In the exemplary embodiment, the tapes 311 and 312 may extend, not only on the divided ends 261 of the divided pieces 26A and 26B, but further to a region beyond the divided ends 261. On the other hand, the element arrays 312 and 322 are preferably disposed on the respective divided ends 261 of the divided pieces 26A and 26B. Specifically, the element arrays 312 and 322 are preferably disposed in the respective cutouts 27.

The same description as above is also applicable to the divided ends 261 of the divided pieces 26A to 26D coupled by the other slide fasteners 3B to 3D.

In such a configuration, the same effect as in the first exemplary embodiment is achieved, and the work of sewing the slide fasteners 3A to 3D to the divided pieces 26A to 26D is made easier.

In addition, in the exemplary embodiment, the overall rigidity of the roof lining 1 can be adjusted by appropriately adjusting the range of the base 24 to be removed from the divided ends 261 of the divided pieces 26A to 26D.

Further, in the exemplary embodiment, the slide fasteners 3A to 3D can be prevented from protruding toward the +Z side in the roof lining 1, thereby improving appearance of the roof lining 1.

### Third Exemplary Embodiment

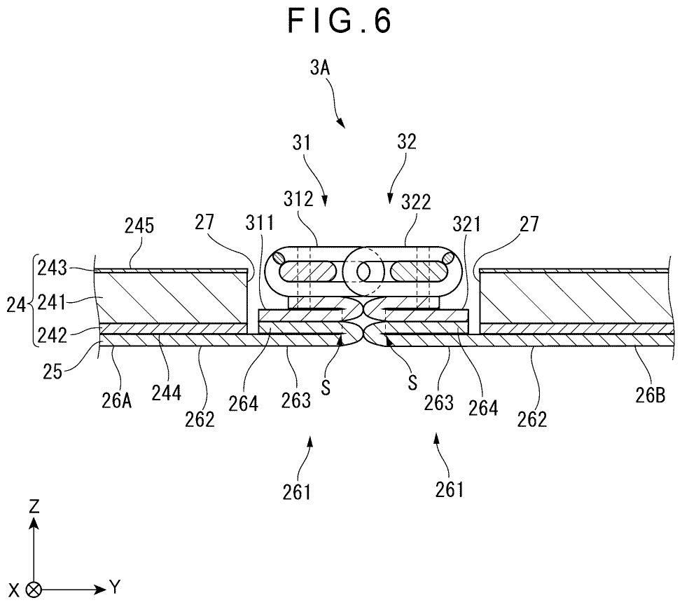

A roof lining 1 of the third exemplary embodiment, which is a modification of the roof lining 1 of the first exemplary embodiment, is different in the details of the divided ends 261 of the divided pieces 26A to 26D. Hereinafter, the divided ends 261 of the divided pieces 26A and 26B coupled by the slide fastener 3A as a representative example are described with reference to FIG. 6.

As illustrated in FIG. 6, the base 24 is entirely removed from the divided ends 261 of the divided pieces 26A and 26B; only the cover material 25 is present at the divided ends 261. Accordingly, the cutout 27, which is opened in the +Z direction and toward one side in the Y direction, is formed in each of the divided ends 261 of the divided pieces 26A and 26B.

The divided end 261 of the divided piece 26A has a base-side region 263 and a distal-side region 264. The base-side region 263 is connected to a body 262 (i.e., a portion of the divided piece 26A where the base 24 is present) of the divided piece 26A. The distal-side region 264 is folded to overlap the base-side region 263.

Similar to the divided end 261 of the divided piece 26A, the divided end 261 of the divided piece 26B has the base-side region 263 and the distal-side region 264.

The fold at the divided end 261 of the divided piece 26A and the fold at the divided end 261 of the divided piece 26B are arranged to contact or be close to each other in the Y direction.

Here, the slide fastener 3A is disposed on the distal-side regions 264 at the divided ends 261 of the divided pieces 26A and 26B. This slide fastener 3A may be a so-called concealed fastener.

For instance, the tape 311 of the fastener stringer 31 is folded in a middle portion of the width direction. This tape 311 has one folded piece attached with the element array 312 and the other folded piece sewn onto the distal-side region 264 of the divided piece 26A.

Similarly, the tape 321 of the fastener stringer 32 is folded in a middle portion of the width direction. This tape 321 has one folded piece attached with the element array 322 and the other folded piece sewn onto the distal-side region 264 of the divided piece 26B.

The same description as above is also applicable to the divided ends 261 of the divided pieces 26A to 26D coupled by the other slide fasteners 3B to 3D.

In such a configuration, the same effect as in the first exemplary embodiment is achieved, and the work of sewing the slide fasteners 3A to 3D to the divided pieces 26A to 26D is made easier.

The exemplary embodiment allows for a design in which both the slide fasteners 3A to 3D and the distal-side regions 264 (i.e., regions including end surfaces of the divided pieces 26A to 26D) of the divided pieces 26A to 26D are invisible to a passenger.

### Fourth Exemplary Embodiment

A roof lining 1 of the fourth exemplary embodiment, which is a modification of the roof lining 1 of the first exemplary embodiment, is different in the details of the divided ends 261 of the divided pieces 26A to 26D.

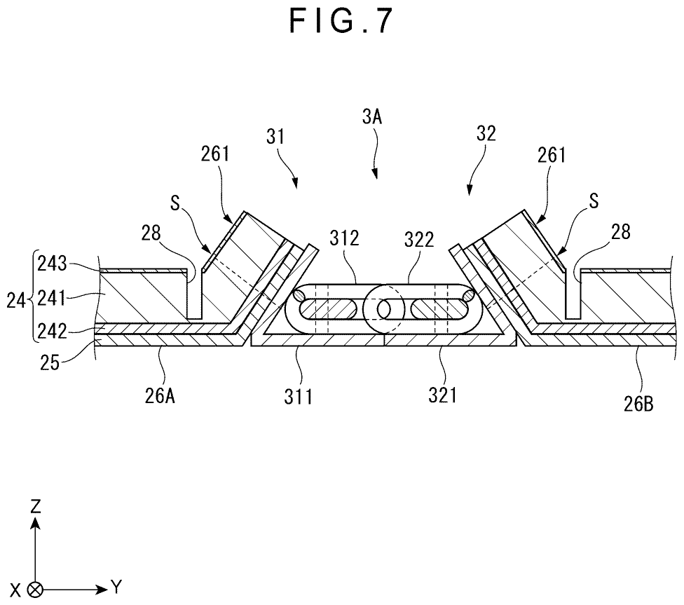

Hereinafter, the divided ends 261 of the divided pieces 26A and 26B coupled by the slide fastener 3A as a representative example are described with reference to FIG. 7.

In the exemplary embodiment, the slide fastener 3A is placed on and attached to the cover material 25 over the divided ends 261 of the respective divided pieces 26A and 26B. The divided ends 261 of the respective divided pieces 26A and 26B are folded toward the +Z side together with portions of the slide fastener 3A (specifically, an opposite end of the widthwise ends of each of the tapes 311 and 312 from the corresponding one of element arrays 312 and 322).

This makes the slide fastener 3A to be partially exposed toward the −Z side from between the divided ends 261 of the divided pieces 26A and 26B.

The same description as above is also applicable to the divided ends 261 of the divided pieces 26A to 26D coupled by the other slide fasteners 3B to 3D.

The exemplary embodiment described above allows the yield in production of the roof lining 1 to improve as in the first exemplary embodiment.

Further, in the exemplary embodiment, the slide fasteners 3A to 3D can be exposed to space inside the vehicle body from between the divided ends 261. This allows for a design in which the slide fasteners 3A to 3D are visible to passengers.

In the exemplary embodiment, each of the divided pieces 26A and 26B has a slit 28 opened in the +Z direction while extending in the X direction along the corresponding divided end 261. This makes it easy to fold the divided pieces 26A and 26B toward the +Z side even when the base 24 of each of the divided pieces 26A and 26B has a large thickness.

### Fifth Exemplary Embodiment

A roof lining 1 of the fifth exemplary embodiment, which is a modification of the roof lining 1 of the fourth exemplary embodiment, is different in the details of the divided ends 261 of the divided pieces 26A to 26D.

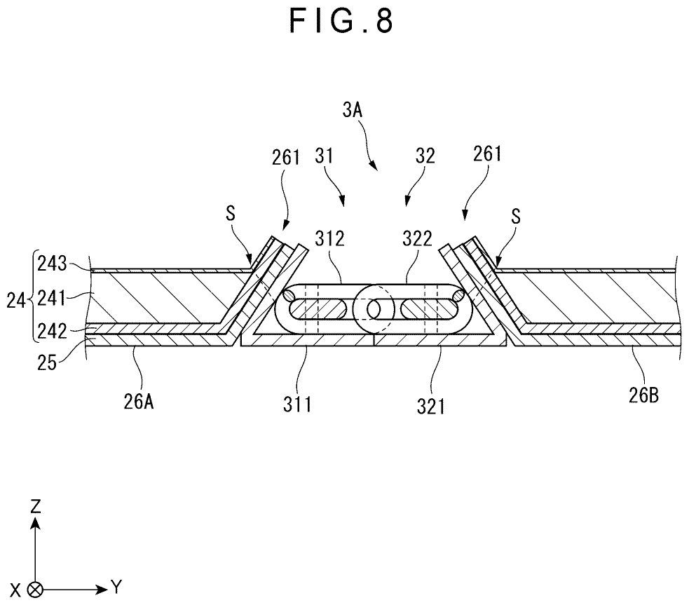

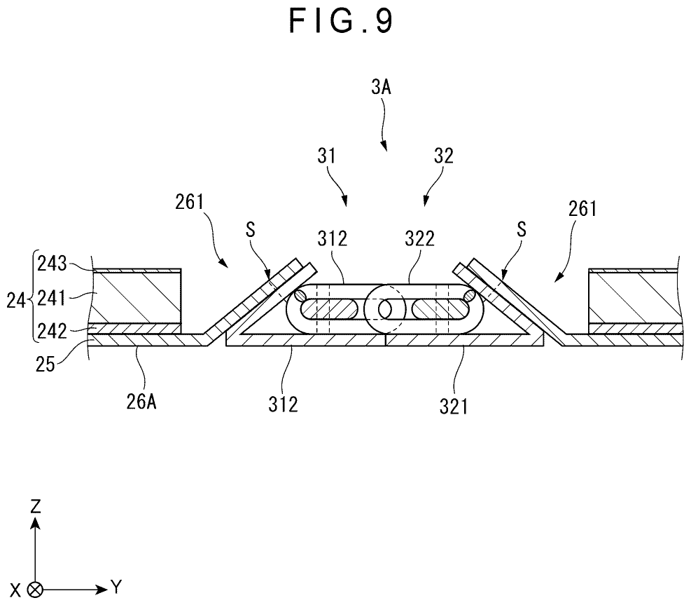

Hereinafter, the divided ends 261 of the divided pieces 26A and 26B coupled by the slide fastener 3A as a representative example are described with reference to FIGS. 8 and 9.

In the exemplary embodiment, at least a part of the base 24 is removed from each of the divided ends 261 of the divided pieces 26A and 26B.

For instance, as illustrated in FIG. 8, at each of the divided ends 261 of the divided pieces 26A and 26B, the urethane layer 241 may be removed from the base 24, and the first glass fiber layer 242, the second glass fiber layer 243, and the cover material 25 may be stacked.

Alternatively, as illustrated in FIG. 9, the base 24 may be entirely removed from the divided ends 261 of the divided pieces 26A and 26B. In this case, only the cover material 25 is present at the divided ends 261.

In the exemplary embodiment, the divided ends 261 of the respective divided pieces 26A and 26B are folded toward the +Z side together with portions of the slide fastener 3A (specifically, an opposite end of the widthwise ends of each of the tapes 311 and 321 from the corresponding one of the element arrays 312 and 322), as in the fourth exemplary embodiment. This makes the slide fastener 3A to be partially exposed toward the −Z side from between the divided ends 261 of the divided pieces 26A and 26B.

The same description as above is also applicable to the divided ends 261 of the divided pieces 26A to 26D coupled by the other slide fasteners 3B to 3D.

The exemplary embodiment described above allows the yield in production of the roof lining 1 to improve as in the first exemplary embodiment. Further, the exemplary embodiment allows for a design in which the slide fasteners 3A to 3D are visible to passengers, as in the fourth exemplary embodiment. Furthermore, the exemplary embodiment makes it easier to sew the slide fasteners 3A to 3D onto the divided pieces 26A to 26D.

In addition, in the exemplary embodiment, the overall rigidity of the roof lining 1 can be adjusted by appropriately adjusting the range of the base 24 to be removed from the divided ends 261 of the divided pieces 26A to 26D.

### MODIFICATIONS

In each of the above exemplary embodiments, the overall shape of the lining material 2, the position of the opening 21 in the lining material 2, and the shape of the opening 21 can be changed as appropriate to conform to the ceiling of the vehicle body. In addition, the number of divisions of the lining material 2 (i.e., the number of divided pieces 26A to 26D and the number of slide fasteners 3A to 3D) can be changed optionally.

In each of the above exemplary embodiments, the positions of the slide fasteners 3A to 3D are changeable optionally as long as the slide fasteners 3A to 3D are positioned so as to traverse the lining material 2 from the opening 21 to the outer edge 23 of the lining material 2. For instance, the slide fasteners 3A to 3D may be disposed not along the X direction but along another direction such as the Y direction.

In each of the above exemplary embodiments, two slide fasteners 3A and 3B (or 3C and 3D) are disposed on one parting line L1 (or L2). However, the invention is not limited thereto. For instance, the slide fasteners 3A to 3D may be disposed on mutually different parting lines.

In each of the above exemplary embodiments, the element arrays 312 and 322 are respectively disposed on the +Z side surfaces of the tapes 311 and 321, but may be respectively disposed on −Z side surfaces of the tapes 311 and 321. In this case, in the fourth and fifth exemplary embodiments, the element arrays 312 and 322 of the slide fastener 3A may be exposed toward the −Z side from between the divided ends 261 of the respective divided pieces 26A and 26B.

In each of the above exemplary embodiments, the slide fasteners 3A to 3D are each a coil fastener. However, the invention is not limited thereto. For instance, the slide fasteners 3A to 3D may each be a metal fastener with metal element arrays 312 and 322, or a resin fastener with injection-molded element arrays 312 and 322.

In each of the above exemplary embodiments, each of the slide fasteners 3A to 3D includes the tapes 311 and 312 and the element arrays 312 and 322. However, the invention is not limited thereto. For instance, in the second exemplary embodiment, each of the slide fasteners 3A to 3D may include the element arrays 312 and 322 directly attached to the divided ends 261 of the divided pieces 26A to 26D.

In each of the above exemplary embodiments, each of the slide fasteners 3A to 3D is attached, by sewing, to the corresponding ones of the divided pieces 26A to 26D. However, the invention is not limited thereto but may be attached using an adhesive or the like.

1. A roof lining comprising:
a lining material comprising a plurality of divided pieces to define an opening corresponding to a sunroof of a vehicle body; and
a plurality of slide fasteners, each of which is configured to couple adjacent ones of the divided pieces, wherein
the slide fasteners traverse the lining material from the opening to an outer edge of the lining material.

2. The roof lining according to claim 1, wherein the slide fasteners are disposed along a front-back direction of the vehicle body.

3. The roof lining according to claim 1, wherein the slide fasteners are respectively attached to portions of the lining material which are on an identical plane.

4. The roof lining according to claim 1, wherein the slide fasteners are attached to a portion having a smallest thickness of the lining material.

5. The roof lining according to claim 1, wherein
each of the slide fasteners comprises a pair of fastener stringers respectively attached to adjacent ones of the divided pieces and configured to be engaged with each other, and
the fastener stringers respectively include:
tapes respectively attached to corresponding ones of the divided pieces, and
element arrays attached to the respective tapes.

6. The roof lining according to claim 5, wherein
each of the divided pieces has divided ends, each of which is adjacent to a corresponding one of the divided pieces, and
each of the element arrays is disposed to overlap a corresponding one of the divided ends in a thickness direction of the lining material.

7. The roof lining according to claim 1, wherein
the lining material comprises:
a base having a single-layered or multi-layered structure; and
a cover material covering a surface of the base on a first side in the thickness direction of the lining material, and
the slide fasteners are disposed on a second side in the thickness direction of the lining material with respect to the lining material.

8. The roof lining according to claim 1, wherein each of the slide fasteners is partially exposed toward a first side in the thickness direction of the lining material, from between adjacent ones of the divided pieces.

9. The roof lining according to claim 8, wherein
each of the divided pieces has divided ends, each of which is adjacent to a corresponding one of the divided pieces, and
each of the divided ends is folded together with a portion of a corresponding one of the slide fasteners toward a second side in the thickness direction of the lining material.

10. The roof lining according to claim 1, wherein
each of the divided pieces has divided ends, each of which is adjacent to a corresponding one of the divided pieces,
each of the divided ends has a base-side region connected to a body of a corresponding one of the divided pieces and a distal-side region folded to overlap the base-side region, and
each of the slide fasteners is disposed on the distal-side regions of adjacent ones of the divided ends.

11. The roof lining according to claim 6, wherein
the lining material comprises:
a base having a single-layered or multi-layered structure; and
a cover material covering a surface of the base on a first side in the thickness direction of the lining material, and
at least a part of the base is removed from each of the divided ends.

12. A production method of a roof lining, comprising:
forming, as a lining material, a plurality of divided pieces that define an opening corresponding to a sunroof of a vehicle body; and
coupling adjacent ones of the divided pieces using a corresponding one of slide fasteners, wherein
the slide fasteners traverse the lining material from the opening to an outer edge of the lining material.

13. The roof lining according to claim 9, wherein
the lining material comprises:
a base having a single-layered or multi-layered structure; and
a cover material covering a surface of the base on a first side in the thickness direction of the lining material, and
at least a part of the base is removed from each of the divided ends.

14. The roof lining according to claim 10, wherein
the lining material comprises:
a base having a single-layered or multi-layered structure; and
a cover material covering a surface of the base on a first side in the thickness direction of the lining material, and
at least a part of the base is removed from each of the divided ends.
